(19) United States
(12) Patent Application Publication
(10) Pub. No.: US 2007/0282497 A1
(43) Pub. Date: Dec. 6, 2007

(54) Power regulating circuit assembly for moto vehicles

(76) Inventor: Shuen-Ri Jou, Sindian City (TW)

Correspondence Address: PRO-TECHTOR INTERNATIONAL SERVICES, 20775 NORADA CT., SARATOGA, CA, 95070, US

(21) Appl. No.: 11/445,964

(22) Filed: Jun. 1, 2006

(51) Int. Cl. G06F 17/00

(52) U.S. Cl. 701/36; 701/1

(57) ABSTRACT

A power regulating circuit assembly includes a circuit board electrically connected to the car battery, a capacitor set, a power transistor electrically coupled to the capacitor set for controlling the capacitor set to discharge accumulated electric current automatically, a solenoid switch electrically coupled to the capacitor set for controlling the capacitor set to discharge accumulated electric current manually, and an IC electrically coupled to the power transistor and the solenoid switch for auto/manual control.

### BACKGROUND OF THE INVENTION

1. Field of the Invention

The present invention relates to a power regulating circuit assembly and more particularly, to a power regulating circuit assembly for use in a motor vehicle to automatically regulate the supply of power and to enhance the horsepower of the motor vehicle, for enabling the motor vehicle to accelerate the speed or to move over a slope smoothly.

2. Description of the Related Art

When a motor vehicle is accelerating or moving over a slope, the current load is relatively increased, and the current outputted from the car battery may be insufficient at this time, causing the motor vehicle unable to accelerate the speed or to move over the slope smoothly. Taiwan Utility M266199 involves a teaching to stabilize the supply of electric current by means of discharging accumulated electric current from capacitors when the load of the motor vehicle is high. This teaching uses an extension line to hold a coil. When electricity is connected to the coil, the coil produces a magnetic field to stabilize and enhances electric current. This design improves the current deficit drawback of conventional vehicle power supply systems. However, the fabrication of this design is complicated. Further, this design does not allow auto/manual control selection.

### SUMMARY OF THE INVENTION

The present invention has been accomplished under the circumstances in view. According to one aspect of the present invention, the power regulating circuit assembly comprises a circuit board carrying a capacitor set, a power transistor, a solenoid switch, and an IC. The capacitor set, the power transistor and the solenoid switch are electrically connected together. The power transistor and the solenoid switch are electrically connected to the IC and then to the computer of the motor vehicle through a manual/auto switch. If the current load is insufficient when the motor vehicle is accelerating or moving over a slope, the power transistor controls the capacitor set to discharge accumulated electric current to the power system of the motor vehicle, thereby stabilizing the supply of electric current. Therefore, the invention enhances the horsepower of the motor vehicle, for enabling the motor vehicle to accelerate the speed or to move over the slope smoothly.

According to another aspect of the present invention, the capacitor set can be made having different pairs of capacitors connected in parallel or series, or a plurality of capacitors of same specification connected in parallel or series.

According to still another aspect of the present invention, the capacitor set can be made having a plurality of capacitors of same or different specifications arranged into different combinations and connected in parallel or series.

According to still another aspect of the present invention, the circuit board is mounted in one side chamber of the car battery.

### BRIEF DESCRIPTION OF THE DRAWINGS

FIG. 1 is a perspective view of a power regulating circuit assembly according to the present invention.

FIG. 2 is a perspective view of an alternate form of the power regulating circuit assembly according to the present invention.

FIG. 3 is a perspective view of another alternate form of the power regulating circuit assembly according to the present invention.

FIG. 4 is a system block diagram of the present invention.

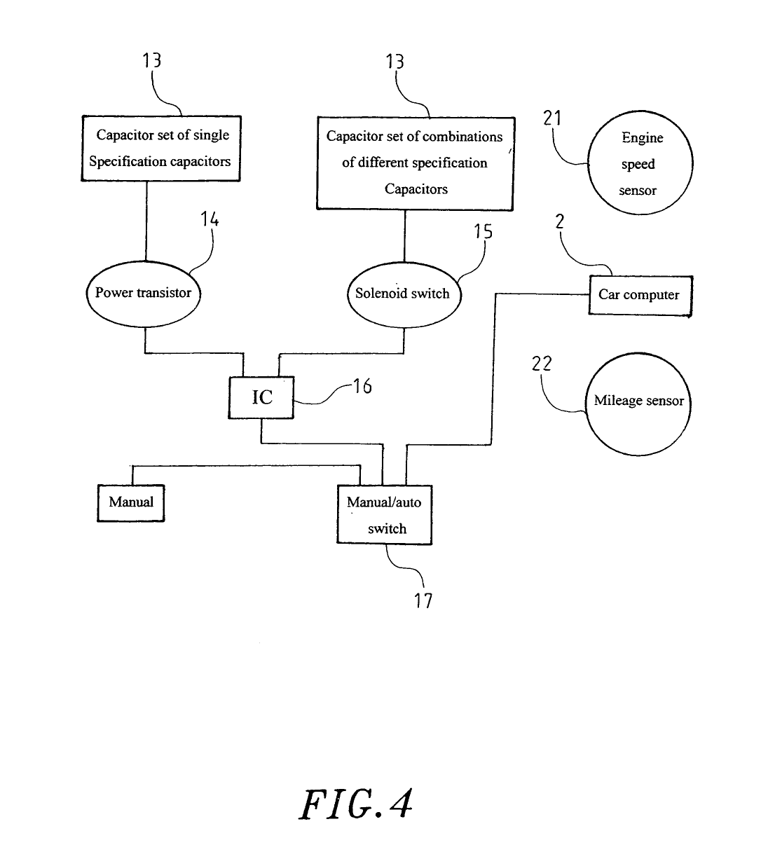

FIG. 5 shows the power regulating circuit assembly incorporated into a car battery according to the present invention.

### DETAILED DESCRIPTION OF THE PREFERRED EMBODIMENT

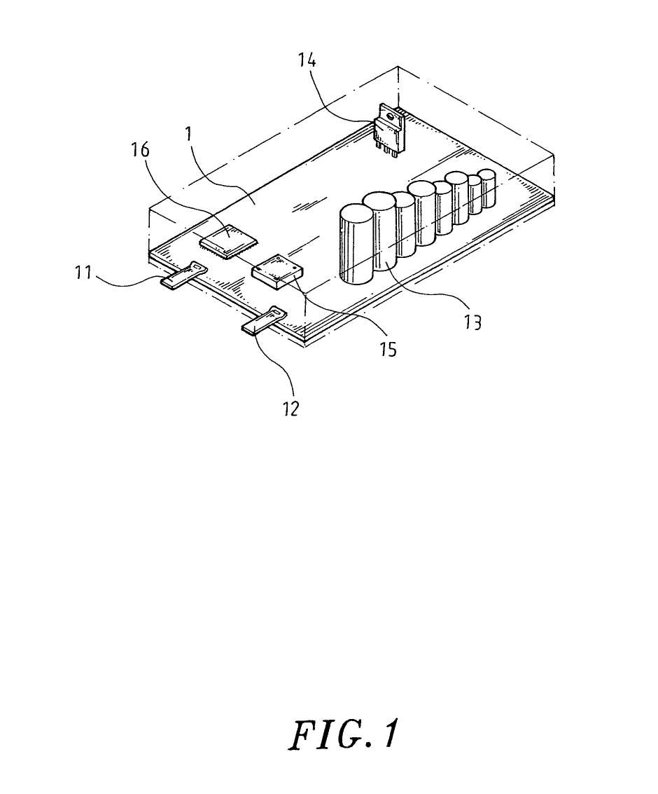

Referring to FIGS. 1˜4, a power regulating circuit assembly in accordance with the present invention is shown comprising a circuit board 1. The circuit board 1 comprises a positive terminal 11 and a negative terminal 12 for connection to the positive and negative terminals of the battery of a motor vehicle, a set of capacitors 13 of same or different specifications, a power transistor 14 electrically coupled to the capacitors 13, a solenoid switch 15, and an IC 16 electrically connected to the power transistor 14 and the solenoid switch 15. The IC 16 is also electrically connected to a computer 2 of the motor vehicle through a manual/auto switch 17. The computer 2 is electrically connected to the engine speed sensor 21 and mileage sensor 22 of the motor vehicle.

If the current load is insufficient when the motor vehicle is accelerating or moving over a slope, the power transistor 14 or the solenoid switch 15 is activated to discharge accumulated electric current from the capacitors 13 through the positive terminal 11 and the negative terminal 12 to the power system (engine) of the motor vehicle, thereby stabilizing the supply of electric current to enhance the horsepower of the motor vehicle for enabling the motor vehicle to accelerate the speed or to move over the slope smoothly. Further, the IC 16 controls the regulation of the voltage or current subject to the position of the manual/auto switch 17.

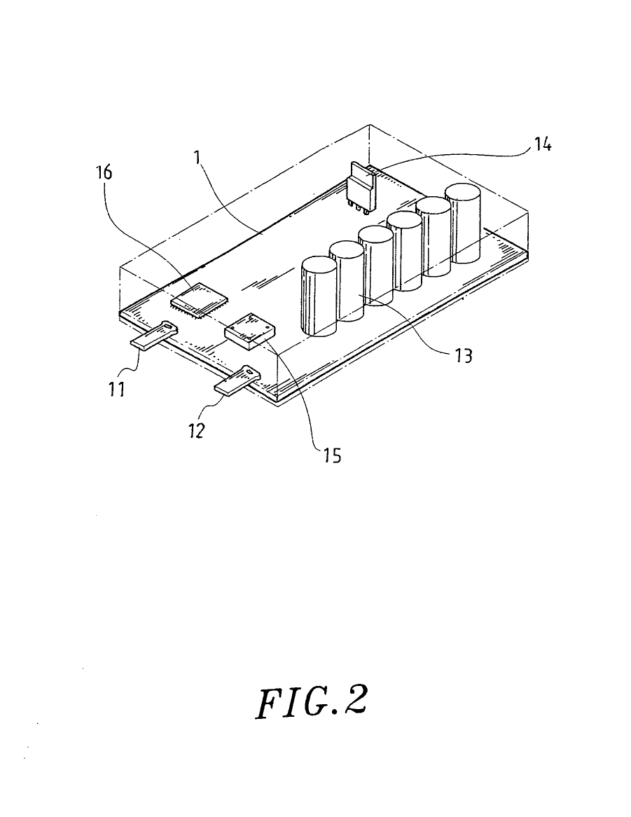

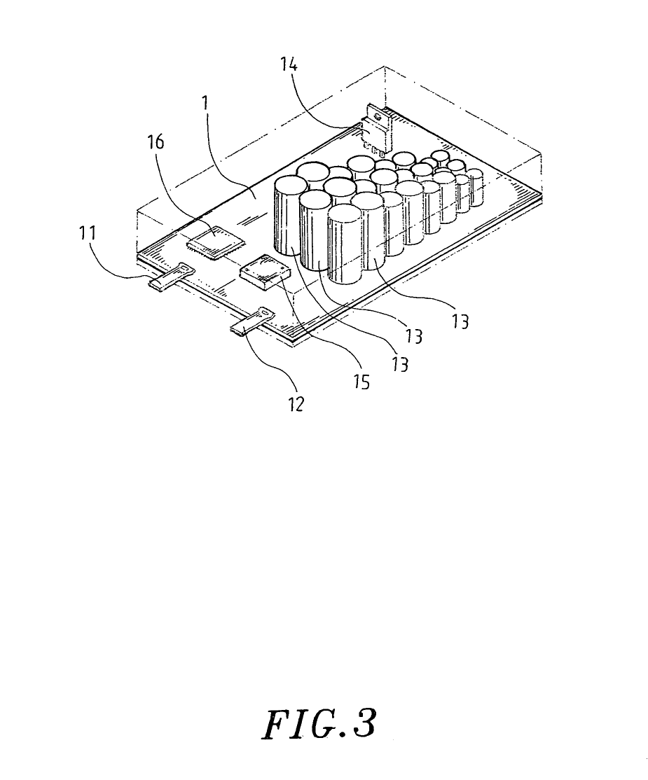

Further, the circuit board 1 can be constructed different pairs of capacitors 13 connected in parallel or series as shown in FIG. 1, or having a plurality of capacitors 13 of same specification connected in parallel or series as shown in FIG. 2, or a plurality of capacitors 13 of same or different specifications arranged into different combinations and connected in parallel or series as shown in FIG. 3.

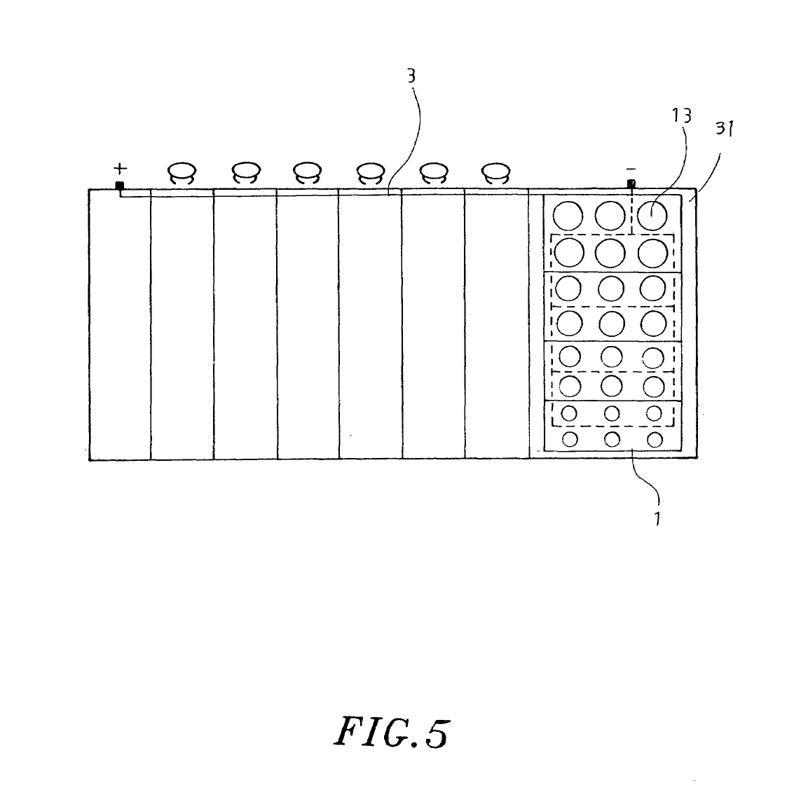

Referring to FIG. 5, the power regulating circuit assembly can be mounted in a side chamber 31 of a car battery 3 to regulate the output of the car battery 13 subject to the operation status of the motor vehicle in which the car battery 3 is installed. When the motor vehicle is accelerating or moving over a slope, the power regulating circuit assembly automatically regulates the output of the car battery 3 to enhance the horsepower of the motor vehicle for enabling the motor vehicle to accelerate the speed or to move over the slope smoothly.

Although particular embodiments of the invention have been described in detail for purposes of illustration, various modifications and enhancements may be made without departing from the spirit and scope of the invention. Accordingly, the invention is not to be limited except as by the appended claims.

What the invention claimed is:

1. A power regulating circuit assembly comprising:
a circuit board mounted in a motor vehicle having a car battery, said circuit board having a positive terminal and a negative terminal respectively electrically connected to positive and negative terminals of the car battery of said motor vehicle;
a capacitor set installed in said circuit board;
a power transistor installed in said circuit board and electrically coupled to said capacitor set for controlling said capacitor set to discharge accumulated electric current;
a solenoid switch electrically coupled to said capacitor set for controlling said capacitor set to discharge accumulated electric current; and
an IC electrically coupled to said power transistor and said solenoid switch for auto/manual control.

2. The power regulating circuit assembly as claimed in claim 1, wherein said capacitor set comprises different pairs of capacitors connected in parallel or series, or a plurality of capacitors of same specification connected in parallel or series.

3. The power regulating circuit assembly as claimed in claim 1, wherein said capacitor set comprises a plurality of capacitors of same or different specifications arranged into different combinations and connected in parallel or series.

4. The power regulating circuit assembly as claimed in claim 1, wherein said circuit board is mounted in one side chamber of said car battery.
